(19) United States
(12) Patent Application Publication
(10) Pub. No.: US 2003/0094065 A1
(43) Pub. Date: May 22, 2003

(54) Spiral-armored cable connection

(76) Inventor: George Zusman, Houston, TX (US)

Correspondence Address: JACKSON WALKER, L.L.P., SUITE 2100, 112 EAST PECAN ST., SAN ANTONIO, TX, 78205, US

(21) Appl. No.: 09/989,968

(22) Filed: Nov. 21, 2001

(51) Int. Cl. F16C 1/22

(52) U.S. Cl. 74/502.6

(57) ABSTRACT

A connector apparatus and method for connection is disclosed for connecting a spiral-armored cable to an instrument or device used in detecting and measuring mechanical vibrations such as a vibration sensor. The connector apparatus includes a threaded connection port for receiving a spiral-armored cable. The connection is further secured by applying epoxy to the area of engagement to bond the connector apparatus and spiral-armored cable together. The resulting threaded connection provides enhanced strength and endurance to allow the connection to withstand long-term exposure to machine vibrations in contrast to prior art crimped connections.

### BACKGROUND OF THE INVENTION

1. Field of the Invention

The present invention relates to shielded cables which are used in vibration detection and monitoring operations. More particularly, the present invention relates to an apparatus and method for connecting spiral-armored cables to vibration detection and monitoring instruments, such as vibration sensors.

2. Description of the Prior Art

Vibration sensors are used in seismic condition monitoring of machines to measure mechanical health and to predict critical machine failures. Seismic vibration is a significant parameter in monitoring the operating condition of critical plant machines. Particularly, vibration monitoring of critical plant machines detects out-of-alignment conditions before they become catastrophic and therefore prevents costly downtime of the machine and personal injury to machine operators.

In operation, a vibration sensor, such as an accelerometer or velocity sensor, is mounted to a machine which is to be monitored. The sensor detects the rate of mechanical displacement or acceleration experienced by the machine and converts this motion into a proportional electrical signal. The signal is received by a monitor device via a cable connecting the sensor to the monitoring device. The cable is shielded by flexible, spiraled armor to protect the cable from potentially damaging operating conditions. Additionally, a signal conditioner, such as an attenuator, amplifier, signal converter, or filter, may be installed between the sensor and the monitor to alter the signal as required by the monitor. Upon receiving the signal, the monitor displays the signal to be read by a machine operator or programmable logic controller (“PLC”). Finally, the operator or PLC compares the signal to a predetermined acceptable level to detect when the machine is out-of-alignment and must be shut down for appropriate maintenance.

While vibration sensors are excellent for monitoring machines for out-of-alignment conditions, problems have been observed with prior art vibration sensors. Particularly, one problem with prior art vibration sensors is the connection between the sensor and the flexible, spiral-armored cable. Traditionally, a vibration sensor includes a body assembly with a connection port which is sized to receive the spiral-armored cable. Once an end of the spiral-armored cable is inserted into the port, the body assembly surrounding the inserted end of the spiral-armored cable is crimped to prevent the cable from dislodging from the sensor port. However, it has been observed that the crimped connection has failed to withstand stress caused by long-term exposure to mechanical vibration typical of critical plant machines.

Moreover, the problem with crimped connections is not limited to connecting a spiral-armored cable to a vibration sensor. The problem with crimped connections is also a concern with respect to connecting a spiral-armored cable to any instrument or device which is exposed to long-term mechanical vibration.

Accordingly, it would be desirable to have a connection between a spiral-armored cable and an instrument or device, such as a vibration sensor, which could withstand long-term exposure to mechanical vibration. This novel and useful result has been achieved by the present invention.

### SUMMARY OF THE INVENTION

In accordance with the present invention, method and apparatus are provided for connecting a spiral-armored cable to an instrument or device which is exposed to long-term mechanical vibration.

In accordance with the present invention, a connector apparatus is provided which comprises a body assembly having a port for connection with a spiral-armored cable. The port defines a threaded axial bore for receiving the spiral-armored cable and forming a threaded connection. This threaded connection secures the spiral-armored cable to the connector apparatus and is capable of withstanding long-term exposure to mechanical vibration.

In accordance with the present invention, the connector apparatus may further comprise epoxy which is used to fix the spiral-armored cable in threaded connection with the port of the connector apparatus.

In a particular embodiment of the present invention, the connector apparatus is a vibration sensor comprising a port which defines a threaded axial bore for connection with a spiral-armored cable.

In another particular embodiment of the present invention, the connector apparatus is an adapter comprising a port which defines a threaded axial bore for connection with a spiral-armored cable. The adapter itself can be attached to an enclosure of an instrument or device which is exposed to long-term mechanical vibration.

In still another particular embodiment of the present invention, the connector apparatus is an end cap comprising a port which defines a threaded axial bore for connection with a spiral-armored cable.

### BRIEF DESCRIPTION OF THE DRAWINGS

In the accompanying drawings:

FIG. 1 is an enlarged profile view of a preferred embodiment of the present invention illustrating a vibration sensor in threaded connection with a spiral-armored cable.

FIG. 2 is a sectional view of a preferred embodiment of the present invention illustrating a tap drill used to cut threads in a connection port of a vibration sensor to allow the port to receive a spiral-armored cable.

FIG. 3 is a sectional view of a preferred embodiment of the present invention illustrating a connection port of a vibration sensor having threads therein to receive a spiral-armored cable.

FIG. 4 is a sectional view of a preferred embodiment of the present invention illustrating a connection port of a vibration sensor receiving a spiral-armored cable.

FIG. 5 is a sectional view of a preferred embodiment of the present invention illustrating a spiral-armored cable in threaded connection with a connection port of an adapter apparatus which is in connection with a through-hole of an instrument enclosure.

FIG. 6 is a sectional view of a preferred embodiment of the present invention illustrating a spiral-armored cable in threaded connection with a connection port of an adapter apparatus which is in connection with a threaded hole of an instrument enclosure.

FIG. 7 is a sectional view of a preferred embodiment of the present invention illustrating a spiral-armored cable in threaded connection with an end cap.

### DESCRIPTION OF SPECIFIC EMBODIMENT

A detailed description of certain embodiments of the present invention is provided to facilitate an understanding of the invention. The detailed description is intended to illustrate particular embodiments of a method and apparatus for connecting a spiral-armored cable to an instrument or device exposed to long-term mechanical vibration. However, it is understood that other embodiments may be provided without departing from the scope of the present invention.

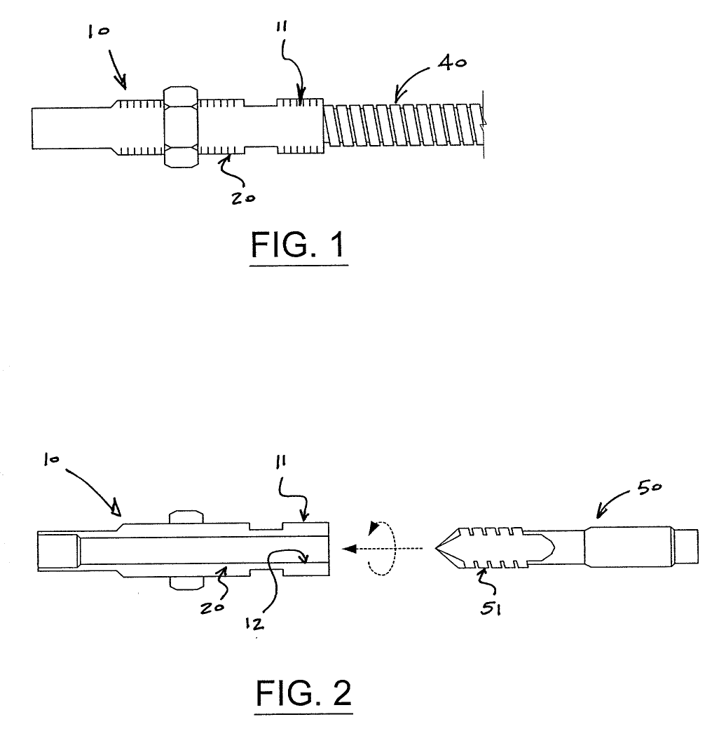

With reference to FIG. 1, in one embodiment of the present invention, the connector apparatus is a vibration sensor 10. The vibration sensor 10 comprises a body assembly 20 having a threaded connection port 11 for receiving a spiral-armored cable 40. While the preferred embodiment of the present invention is preferably used with a cable for a vibration sensor, it is intended that the present invention may be used with any sensor requiring connection with a spiral-armored cable.

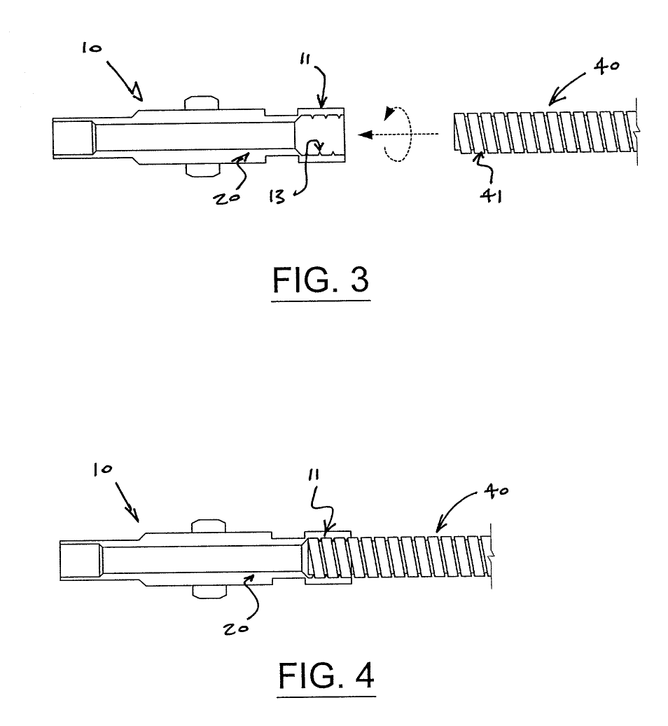

With reference to FIGS. 2, 3, and 4, a vibration sensor 10 in accordance with the present invention includes a body assembly 20 and a connection port 11 defining an axial bore 12 therethrough. A tap drill 50 having threads 51 which correspond to the threads 41 of spiral-armored cable 40 is used to cut threads 13 into surface of the axial bore 12. While a preferred embodiment of the present invention utilizes a tap drill 50 to cut the threads 13, it is intended that the threads of the present invention may be formed by any practical means, including fabricating a sensor body with pre-cast threads. Once drilling is complete, the threads 13 of the axial bore 12 are cleaned to remove debris and drill filings from within the connection port 11. An epoxy (not shown) is then applied to the threads 13 of the axial bore 12. It is understood that applying epoxy to the threads 13 of the bore 12 of the connection port 11 may be done directly or by applying epoxy to the threads 41 of the spiral-armored cable 40 and then screwing the spiral-armored cable into the threads of the connection port. Finally, the spiral-armored cable 40 is screwed into the connection port 11 such that the threads 13 of the axial bore 12 engage the threads 41 of the spiral-armored cable. Once the epoxy dries, the connection is secure.

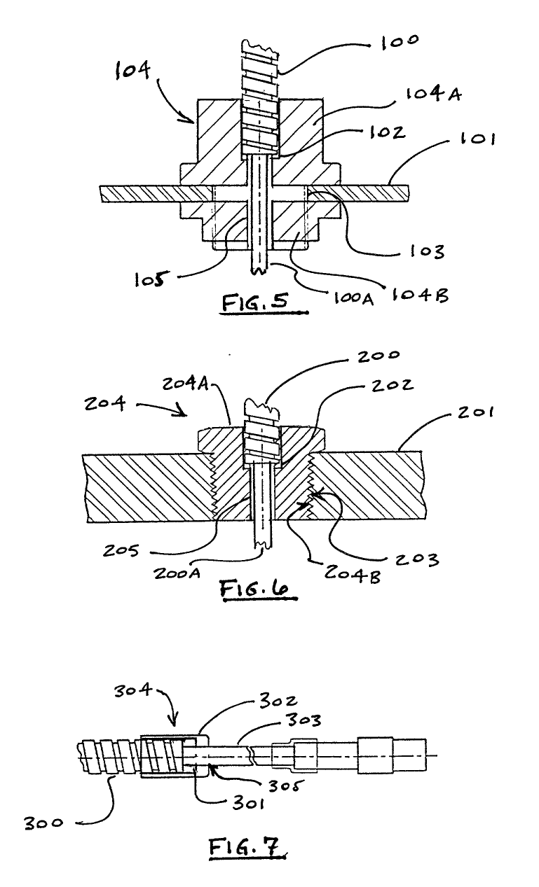

With reference to FIG. 5, in another embodiment of the present invention, the connector apparatus is an adapter 104 for connection with an instrument enclosure 101 having a through hole 103. The adapter 104 comprises an upper body assembly 104A having a threaded connection port 102 for receiving a spiral-armored cable 100, and a lower body assembly 104B for connection with the upper body assembly to clamp the adapter to the instrument enclosure 101. The adapter 104 further comprises an axial bore 105 therethrough. An unshielded portion 100A of the spiral-armored cable 100 passes through the axial bore 105 and inside the instrument enclosure 101 via the through hole 103.

With reference to FIG. 6, an alternative embodiment of the adapter of the present invention is provided. In accordance with the present invention, the connector apparatus may be an adapter 204 for connection with an instrument enclosure 201 having a threaded hole 203. The adapter 204 comprises an bolt head 204A having a threaded connection port 202 for receiving a spiral-armored cable 200, and a threaded bolt shaft 204B for connection with the threaded hole 203 of the instrument enclosure 201. The adapter 204 further comprises an axial bore 205 therethrough. An unshielded portion 200A of the spiral-armored cable 200 passes through the axial bore 205 and inside the instrument enclosure 201 via the threaded hole 203.

With reference to FIG. 7, in still another embodiment of the present invention, the connector apparatus is an end cap 304. The end cap 304 comprises a threaded connection port 301 for receiving a spiral-armored cable 300. The end cap 304 may further comprise an axial bore 305 through which an unshielded portion 303 of the spiral-armored cable 300 passes.

The advantages of each connector apparatus described in the preferred embodiments in accordance with the present invention are provided by the threaded connection port in lieu of prior art connectors which employ crimped connections. The present invention provides an enhanced connection that enables the connector apparatus to maintain contact with the spiral-armored cable during long-term machine vibration conditions. These and other advantages of the present invention will be apparent to those skilled in the art.

What is claimed is:

1. A connector apparatus, comprising a body assembly having a port for connection with a spiral-armored cable, said port defining an axial bore with threads formed in the surface of the bore for receiving the spiral-armored cable.

2. The connector apparatus of claim 1, further comprising an epoxy applied to area of connection between the threaded port and the spiral-armored cable.

3. The connector apparatus of claim 1, wherein said connector apparatus is a vibration sensor.

4. The connector apparatus of claim 3, wherein said vibration sensor is a velocity sensor.

5. The connector apparatus of claim 3, wherein said vibration sensor is an accelerometer.

6. The connector apparatus of claim 1, wherein said connect or apparatus is an adapter for connection with an instrument enclosure.

7. The connector apparatus of claim 1, wherein said connector apparatus is an end cap.

8. A method for connecting a spiral-armored cable to a connector apparatus having a connection port, comprising:
(a) forming a threaded axial bore in a connection port of the connector apparatus with a drill tap, said threaded axial bore corresponding to the pattern of the outer surface of the spiral-armored cable;
(b) applying epoxy to the threaded axial bore of the connection port; and
(c) screwing the spiral-armored cable into the threaded axial bore of the connection port such that the epoxy bonds the spiral-armored cable to the connection port of the connector apparatus.

9. The method of claim 8, wherein said connector apparatus is a vibration sensor.

10. The method of claim 9, wherein said vibration sensor is a velocity sensor.

11. The method of claim 9, wherein said vibration sensor is an accelerometer.

12. The method of claim 8, wherein said connector apparatus is an adapter for connection with an instrument enclosure.

13. The method of claim 8, wherein said connector apparatus is an end cap.
